(19) United States
(12) Patent Application Publication
(10) Pub. No.: US 2017/0192125 A1
(43) Pub. Date: Jul. 6, 2017

(54) Molecular Factor Computing Sensor for Intelligent Well Completion

(71) Applicant: Halliburton Energy Services, Inc., Houston, TX (US)

(72) Inventors: William C. PEARL, JR., Houston, TX (US); Megan R. PEARL, Houston, TX (US)

(73) Assignee: Halliburton Energy Services, Inc., Houston, TX (US)

(21) Appl. No.: 15/314,670

(22) PCT Filed: Jul. 17, 2014
(86) PCT No.: PCT/US2014/046994

§ 371 Date: Nov. 29, 2016

(51) Int. Cl. G01V 9/00; E21B 47/06; E21B 49/08

(52) U.S. Cl. CPC G01V 9/005; E21B 49/08; E21B 47/065; E21B 34/06

(57) ABSTRACT

A molecular factor computing sensor for use in a subterranean well can include a thermal detector, a layer of an electromagnetic energy absorptive composition, and an electromagnetic energy source. The thermal detector is sensitive to electromagnetic energy from the electromagnetic energy source and absorbed by the electromagnetic energy absorptive composition. A method of identifying at least one chemical identity of a substance in a subterranean well can include positioning at least one molecular factor computing sensor in the well, and the molecular factor computing sensor outputting at least one signal indicative of the chemical identity of the substance. A system for use with a subterranean well can include at least one molecular factor computing sensor that outputs a signal indicative of a chemical identity of a substance in the well. The substance flows between an earth formation and a wellbore that penetrates the formation.

### TECHNICAL FIELD

This disclosure relates generally to equipment utilized and operations performed in conjunction with a subterranean well and, in one example described below, more particularly provides a molecular factor computing sensor for an intelligent well completion.

### BACKGROUND

An intelligent well completion can be used to regulate flow between an earth formation and a wellbore that penetrates the formation. Typically, an intelligent well completion will include multiple valves, chokes or other types of flow control devices (such as, inflow control devices) to independently regulate flow at multiple corresponding formation zones. Therefore, it will be appreciated that improvements are continually needed in the art of constructing and operating intelligent well completions.

### BRIEF DESCRIPTION OF THE DRAWINGS

FIG. 1 is a representative partially cross-sectional view of a well system and associated method which can embody principles of this disclosure.

FIG. 2 is a representative schematic view of a molecular factor computing sensor that may be used in the well system and method of FIG. 1, and which can embody the principles of this disclosure.

FIG. 3 is a representative schematic of a technique for detecting various different substances using molecular factor computing sensors.

### DETAILED DESCRIPTION

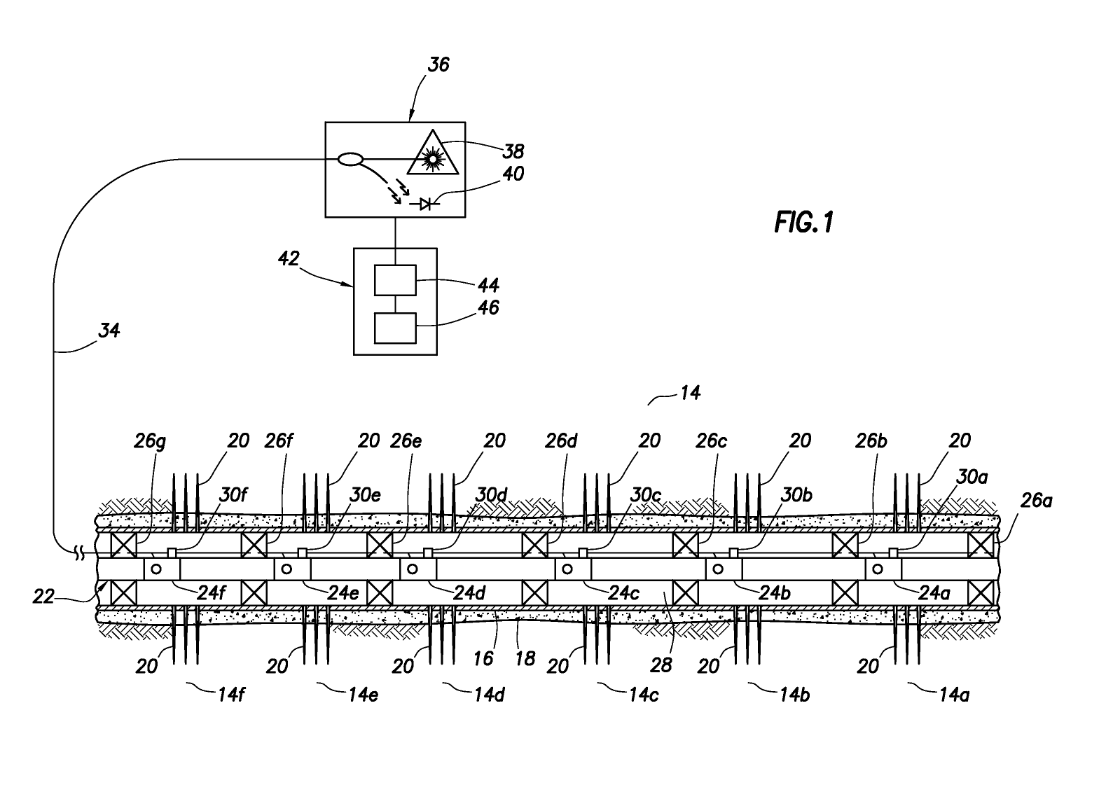

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a wellbore 12 penetrates an earth formation 14. The wellbore 12 depicted in FIG. 1 is generally horizontal, but in other examples the wellbore could extend generally vertically or in an inclined direction in the formation 14.

A section of the wellbore 12 depicted in FIG. 1 is lined with casing 16 and cement 18. In other examples, the section of the wellbore 12 may be uncased or open hole.

Sets of perforations 20 extend through the casing 16 and cement 18, and into the formation 14 to thereby provide for fluid communication between the wellbore 12 and the formation. In the FIG. 1 example, each set of perforations 20 corresponds to a respective one of multiple formation zones 14a-f. In other examples, multiple sets of perforations 20 could be formed into a single zone.

In the FIG. 1 system 10, it is desired to control flow from each of the individual zones 14a-f. For this purpose, a completion string 22 is installed in the wellbore 12.

The completion string 22 includes multiple flow control devices 24a-f (such as, valves, chokes, inflow control devices, etc.) and packers 26a-g for isolating sections of an annulus 28 formed radially between the wellbore 12 and the completion string. Each of the flow control devices 24a-f can, therefore, regulate flow between an interior of the completion string 22 and a respective one of the formation zones 14a-f.

Note that, since a section of the annulus 28 is isolated longitudinally between each adjacent pair of the packers 26a-g, each of the flow control devices 24a-f also regulates flow between the wellbore 12 and each of the formation zones 14a-f. In other examples, the completion string 22 may not be used, and the flow control devices 24a-f could be connected in the casing 16, so that the flow control devices could directly regulate flow between the wellbore 12 and each of the formation zones 14a-f.

In the FIG. 1 example, molecular factor computing sensors 30a-f are positioned in the isolated sections of the annulus 28 between the adjacent pairs of the packers 26a-g. The sensors 30a-f are used to identify a chemical makeup of fluid that flows between the wellbore 12 and the formation 14. In this example, the fluid flows from the formation 14 into the wellbore 12, and it is desired to understand what type of fluid (e.g., oil, gas, water, mixtures thereof, etc.) is flowing from each formation zone 14a-f into the wellbore 12, so that each of the flow control devices 24a-f can be adjusted accordingly.

For example, if it is determined that a relatively large quantity of water is flowing into the wellbore 12 from the formation zone 14a, then it may be desirable to close off, or at least increasingly restrict flow through, the corresponding flow control device 24a. If it is determined that a relatively high quality oil is flowing into the wellbore 12 from the formation zone 14f, then it may be desirable to fully open, or at least reduce restriction to flow through, the corresponding flow control device 24f.

In different circumstances, flow of gas or gas condensate may be desirable or undesirable. Thus, the scope of this disclosure is not limited to any particular manner in which the flow control devices 14a-f are adjusted in response to an indication of chemical identity output by the sensors 30a-f.

In the FIG. 1 example, the sensors 30a-f are depicted as being external to the completion string 22 and attached or connected to the respective flow control devices 24a-f. In other examples, the sensors 30a-f could be otherwise positioned (e.g., external or internal to the casing 16, internal to the completion string 22, etc.), the sensors could be separated from the flow control devices 24a-f, and it is not necessary for there to be a one-to-one correspondence between the sensors and the flow control devices. Thus, it should be clearly understood that the scope of this disclosure is not limited at all to any particular details of use of the sensors 30a-f in the system 10 of FIG. 1.

The sensors 30a-f are depicted in FIG. 1 as being connected to a cable 32 extending externally along the completion string 22. In this example, the cable 32 is used to transmit to a remote location (such as, the earth's surface, a floating rig, a subsea location, etc.) indications of a chemical identity of each of the fluids flowing between the wellbore 12 and the formation zones 14a-f. In other examples, such transmission could be by wireless means (such as, acoustic or electromagnetic telemetry).

In the FIG. 1 example, the cable 32 includes an optical waveguide 34 (such as, an optical fiber or optical ribbon). Additional and different types of lines may be incorporated into the cable 32, such as, electrical conductors, hydraulic conduits, etc. It is not necessary in keeping with the scope of this disclosure for an optical waveguide to be used for transmission of indications of chemical identities of fluids (for example, an electrical conductor could be used for such transmissions).

The optical waveguide 34 extends to an optical interrogator 36 positioned, for example, at a remote surface location. The optical interrogator 36 is depicted schematically in FIG. 1 as including an optical source 38 (such as, a laser, a light emitting diode or a broadband electromagnetic energy producer) and an optical detector 40 (such as, an opto-electric converter or photodiode).

The optical source 38 launches light (electromagnetic energy, in some examples including in infrared and/or ultraviolet spectra) into the waveguide 34, and light returned to the interrogator 36 is detected by the detector 40. Note that it is not necessary for the light to be launched into a same end of the optical waveguide 34 as an end via which light is returned to the interrogator 36.

Other or different equipment (such as, an interferometer or an optical time domain or frequency domain reflectometer) may be included in the interrogator 36 in some examples. The scope of this disclosure is not limited to use of any particular type or construction of optical interrogator.

A computer 42 is used to control operation of the interrogator 36, and to record optical measurements made by the interrogator. In this example, the computer 42 includes at least a processor 44 and memory 46. The processor 44 operates the optical source 38, receives measurement data from the detector 40 and manipulates that data. The memory 46 stores instructions for operation of the processor 44, and stores processed measurement data. The processor 44 and memory 46 can perform additional or different functions in keeping with the scope of this disclosure.

In other examples, different types of computers may be used, and the computer 42 could include other equipment (such as, input and output devices, etc.). The computer 42 could be integrated with the interrogator 36 into a single instrument. Thus, the scope of this disclosure is not limited to use of any particular type or construction of computer.

The optical waveguide 34, interrogator 36 and computer 42 may also comprise a distributed temperature sensing (DTS) system capable of detecting temperature as distributed along the optical waveguide and/or a distributed vibration sensing (DVS), distributed acoustic sensing (DAS) or distributed strain sensing (DSS) system. For example, the interrogator 36 could be used to measure a ratio of Stokes and anti-Stokes components of Raman scattering in the optical waveguide 34 as an indication of temperature as distributed along the waveguide in a distributed temperature sensing (DTS) system.

In other examples, Brillouin scattering may be detected as an indication of temperature as distributed along the optical waveguide 34. In still further examples, stimulated Brillouin and/or coherent Rayleigh scattering may be detected as an indication of acoustic or vibrational energy as distributed along the optical waveguide 34. Thus, the scope of this disclosure is not limited to any particular use or combination of uses for the optical waveguide 34 in the system 10.

The sensors 30a-f are molecular factor computing sensors, in that they use a principle of spectrum-selective absorption to enable identification of a chemical identity of a substance. Molecular factor computing is described, for example, in M. N. Simcock and M. L. Myrick, Tuning D* with Modified Thermal Detectors, Applied Spectroscopy, vol. 60, no. 12 (2006), in U.S. Pat. No. 8,283,633, and in U.S. publication nos. 2013/0140463 and 2013/0140463.

In typical molecular factor computing, one or more thin films of a same or different composition are deposited onto a surface of a thermal detector. Together, these films act to either absorb optical energy from a material of interest, or absorb background optical energy (that is, optical energy from other than the material of interest). The thermal detector detects heat due to the absorption of the optical energy.

In the system 10, it is desired to detect a presence of one or more substances having particular chemical identities (e.g., oil, gas, water). By detecting the presence of one or more of these substances, the flow control devices 24a-f can be selectively adjusted in response, so that more of a desired substance (such as, oil and/or gas) is produced, and/or so that less of an undesired substance (such as, water and/or gas) is produced.

In the FIG. 1 example, the cable 32 is depicted as being connected to each of the flow control devices 24a-f to enable adjustment of the flow control devices from a remote location. However, it is not necessary for the flow control devices 24a-f to be adjusted from a remote location, or for a cable to be used for such adjustments.

In some examples, the indications of chemical identities can be output from the sensors 30a-f in real time (that is, with no more than a few minutes delay), so that the flow control devices 24a-f can also be adjusted in real time in response to the indications. In some examples, the sensors 30a-f can be coupled or connected directly to the respective flow control devices 24a-f, in which case the flow control devices can be adjusted as needed in response to the indications, without a requirement to transmit the indications of chemical identities to a remote location, or a requirement to adjust the flow control devices from the remote location (although the sensors could be directly connected to the flow control devices, and the indications of chemical identity could still be transmitted to a remote location).

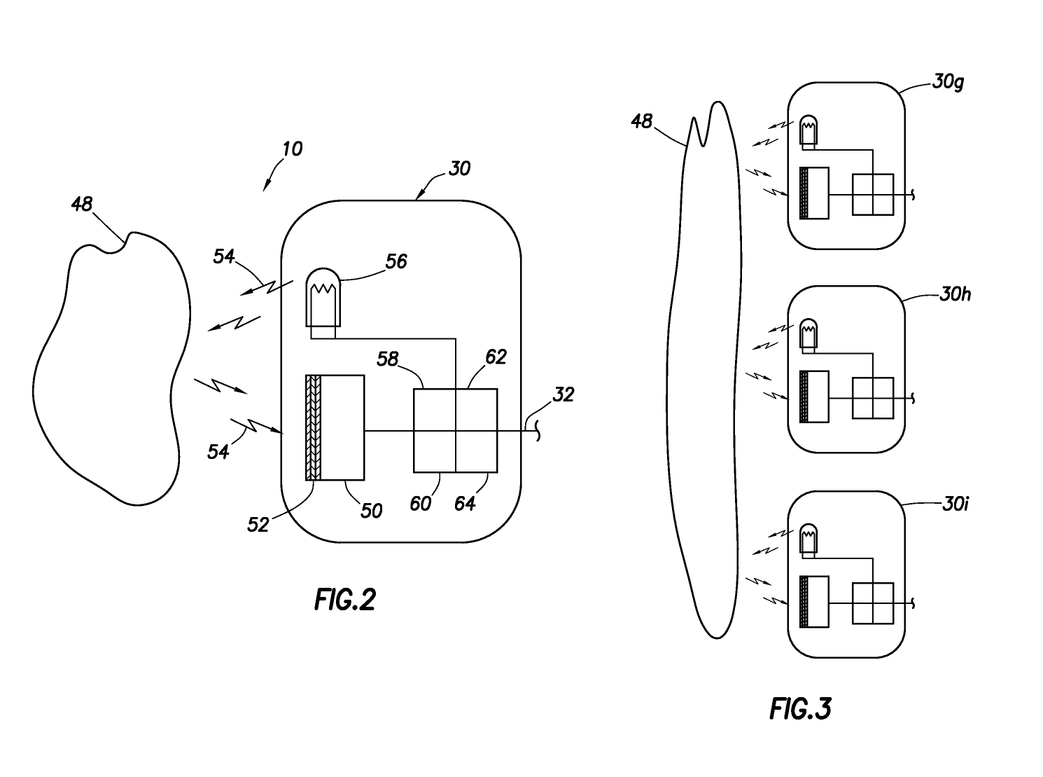

Referring additionally now to FIG. 2, an example of a molecular factor computing sensor 30 that may be used for any of the sensors 30a-f in the system 10 is representatively illustrated. Of course, the sensor 30 may be used in other systems and methods, in keeping with the principles of this disclosure.

In the FIG. 2 example, it is desired to determine whether a substance 48 in the system 10 has a certain chemical identity. The substance 48 in this example could be a portion of a fluid that flows between the formation 14 and the wellbore 12 (see FIG. 1).

Substances with different chemical identities will reflect or transmit corresponding different electromagnetic spectra. Taking advantage of this fact, the sensor 30 includes a thermal detector 50 (such as, a thermopile detector, a pyroelectric detector, etc.) having one or more layers 52 of an electromagnetic energy absorptive composition coupled thereto.

For example, the layers 52 may be formed directly onto a surface of the detector 50, or the layers could be separately formed (e.g., as films, etc.) and then adhered or bonded to the detector surface. The scope of this disclosure is not limited to any particular technique for coupling the one or more layers 52 to the thermal detector 50.

Electromagnetic energy 54 from the substance 48 is at least partially absorbed by the layers 52, and the thermal detector 50 detects such energy absorption. If, for example, the substance 48 comprises an increased concentration of water, and the layers 52 have been selected to absorb electromagnetic energy 54 in a spectrum corresponding to water, then the thermal detector 50 will detect an increase in absorbed energy. If, conversely, the layers 52 have been selected to absorb electromagnetic energy 54 in spectra other than that corresponding to water, then the thermal detector 50 will detect a decrease in absorbed energy. In each of these cases, the increased concentration of water in the substance 48 is indicated by the sensor 30.

The sensor 30 can be similarly constructed to detect oils, gases or other chemical identities in the substance 48. Concentrations of oil, gas, water and/or other chemicals can also be detected. Detection of the presence (or, conversely, the absence) of a particular chemical identity in the substance 48 depends upon whether the layers 52 are selected to absorb (or not absorb) electromagnetic energy from that particular chemical identity.

In some examples, the layers 52 can comprise an electromagnetic energy absorptive composition, such as, transparent polymers (in a chosen spectrum) having a dye mixed therein. The dye could, for example, absorb infrared energy in a specific range of wavelengths. However, the scope of this disclosure is not limited to use of any particular type of electromagnetic energy absorptive composition in the layers 52 of the sensor 30.

In some examples, the layers 52 may not be coupled directly to the thermal detector 50. For example, the electromagnetic energy absorptive composition could be incorporated into a window or filter separate from the thermal detector 50. In this example, the thermal detector 50 could be coated or uncoated.

In the FIG. 2 example, the electromagnetic energy 54 is produced by a relatively broadband electromagnetic energy source 56 (such as, an optical lamp), and is reflected from the substance 48. In other examples, the electromagnetic energy 54 could be transmitted through the substance 48, or could otherwise emanate from the substance (such as, black body radiation). In some examples, the source 54 could produce energy in a specific range of wavelengths (such as, in the infrared and/or near infrared spectrum). In some examples, the electromagnetic energy could be supplied from a remote location, such as the optical source 38 depicted in FIG. 1.

The sensor 30 as depicted in FIG. 2 also includes an electrical power source 58 for providing electrical power to the thermal detector 50 and the electromagnetic energy source 56 (and to other components of the sensor), an amplifier 60 for amplifying a signal output by the thermal detector, and a transmitter 62 for transmitting indications of chemical identities to a remote location, and/or for transmitting instructions for adjustment of a flow control device (such as, any of the flow control devices 24a-f in FIG. 1). Transmissions may be in any form (e.g., optical, electrical, electromagnetic, acoustic, combinations thereof, etc.) with any type of modulation.

The sensor 30 may also include a computer 64 (comprising at least a processor and memory) for various purposes, such as, storing, manipulating and analyzing the indications from the thermal detector 50, determining appropriate flow control device adjustments, formatting and controlling transmissions to the remote location, etc.

Note, however, that the scope of this disclosure is not limited to the particular number or combination of electrical power source 58, amplifier 60, transmitter 62 and computer 64 depicted in FIG. 2 and described herein. Instead, a wide variety of different configurations for the sensor 30 are possible, and a different configuration may be selected for use in a corresponding different well situation. For example, if the sensor 30 is to be coupled directly to a flow control device then the transmitter 62 may not be used, if suitable electrical power is available from the cable 32 then the electrical power source 58 may not be used, if the thermal detector 50 provides sufficient output amplitude then the amplifier 60 may not be used, etc.

Referring additionally now to FIG. 3, another example is representatively illustrated. In this example, multiple sensors 30g-i are used to provide respective multiple indications of chemical identities in the substances 48.

For example, the sensor 30g could be configured to detect presence or absence of oil in the substance 48, the sensor 30h could be configured to detect presence or absence of water in the substance, and the sensor 30i could be configured to detect presence or absence of gas or gas condensate in the substance. Thus, multiple sensors 30g-i can be deployed to detect multiple corresponding chemical identities.

However, in other examples a single sensor 30 could be configured to sense multiple chemical identities. For example, the layers 52 of a sensor 30 could be selected to absorb or exclude absorption of multiple electromagnetic spectra from corresponding multiple chemical identities. As another example, a single sensor 30 could comprise multiple thermal detectors 50 and associated layers 52, and perhaps multiple electromagnetic energy sources 56. Thus, the scope of this disclosure is not limited to any particular details of the construction of the sensor 30 described above or depicted in the drawings.

It may now be appreciated that the above disclosure provides significant advancements to the art of constructing and operating intelligent well completions. In examples described above, the sensor 30 provides indications of chemical identities in the substance 48 flowing between the formation 14 and the wellbore 12, without requiring any moving parts or delay for spectral measurements with a spectrometer. The sensor 30 can be constructed as a robust package suitable for downhole use, and can detect the presence or absence of relatively low concentrations of various chemical identities.

The above disclosure provides to the art a molecular factor computing sensor 30 for use in a subterranean well. In one example, the sensor 30 comprises a thermal detector 50, a layer 52 of an electromagnetic energy absorptive composition, and an electromagnetic energy source 56. The thermal detector 50 is sensitive to electromagnetic energy from the electromagnetic energy source 56 and absorbed by the electromagnetic energy absorptive composition.

The electromagnetic energy source 56 may produce electromagnetic energy 54 that interacts with a substance 48 and is absorbed by the electromagnetic energy absorptive composition of the layer 52. The electromagnetic energy absorptive composition may comprise a polymer and an infrared energy absorptive dye.

The sensor 30 can include a transmitter 62 that transmits to a remote location a signal indicative of a chemical identity of the substance 48.

The thermal detector 50 may be selected from the group consisting of a thermopile detector and a pyroelectric detector.

The sensor 30 can include an amplifier 60 that amplifies an output of the thermal detector 50.

Also described above is a method of identifying at least one chemical identity in a substance 48 in a subterranean well. In one example, the method comprises: positioning at least one molecular factor computing sensor 30 in the well; and the molecular factor computing sensor 30 outputting at least one signal indicative of the chemical identity of the substance 48.

The positioning step can include positioning multiple molecular factor computing sensors 30g-i in the well. In this example, each of the sensors 30g-i may output the signal indicative of the respective chemical identity of the substance 48.

The substance 48 may flow between an earth formation 14 and a wellbore 12 that penetrates the formation 14.

The method can include adjusting a flow control device 24a-f based on the signal. The flow control device 24a-f may control a flow of the substance 48.

The method can include the molecular factor computing sensor 30 transmitting the signal to a remote location.

A well system 10 is also described above. In one example, the well system 10 comprises at least one molecular factor computing sensor 30 that outputs a signal indicative of a chemical identity of a substance 48 in a subterranean well, with the substance 48 flowing between an earth formation 14 and a wellbore 12 that penetrates the formation.

The “at least one” molecular factor computing sensor 30 may comprises multiple molecular factor computing sensors 30g-i, and wherein each of the sensors 30g-i outputs the signal indicative of the chemical identity of the substance 48.

The system 10 can include a flow control device 24a-f which is adjusted in response to the signal. The flow control device 24a-f may control a flow of the substance 48. The molecular factor computing sensor 30 may transmit the signal to a remote location.

The molecular factor computing sensor 30 can comprise a thermal detector 50, and an electromagnetic energy source 56 that produces electromagnetic energy 54 that interacts with the substance 48 and is absorbed by an electromagnetic energy absorptive composition of the sensor 30. The electromagnetic energy 54 produced by the electromagnetic energy source 56 may be relatively broadband.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A molecular factor computing sensor for use in a subterranean well, the sensor comprising:
an electromagnetic energy source;
a layer of an electromagnetic energy absorptive composition; and
a thermal detector sensitive to electromagnetic energy from the electromagnetic energy source and absorbed by the electromagnetic energy absorptive composition.

2. The sensor of claim 1, wherein the electromagnetic energy source produces the electromagnetic energy that interacts with a substance and is absorbed by the electromagnetic energy absorptive composition of the layer.

3. The sensor of claim 2, further comprising a transmitter that transmits to a remote location a signal indicative of a chemical identity of the substance.

4. The sensor of claim 1, wherein the electromagnetic energy absorptive composition comprises a polymer and an infrared energy absorptive dye.

5. The sensor of claim 1, wherein the thermal detector is selected from the group consisting of a thermopile detector and a pyroelectric detector.

6. The sensor of claim 1, further comprising an amplifier that amplifies an output of the thermal detector.

7. A method of identifying at least one chemical identity in a substance in a subterranean well, the method comprising:
positioning at least one molecular factor computing sensor in the well; and
the molecular factor computing sensor outputting at least one signal indicative of the chemical identity of the substance.

8. The method of claim 7, wherein the positioning comprises positioning multiple molecular factor computing sensors in the well, and wherein each of the sensors outputs the signal indicative of the respective chemical identity of the substance.

9. The method of claim 7, wherein the substance flows between an earth formation and a wellbore that penetrates the formation.

10. The method of claim 7, further comprising adjusting a flow control device based on the signal, wherein the flow control device controls a flow of the substance.

11. The method of claim 7, further comprising the molecular factor computing sensor transmitting the signal to a remote location.

12. The method of claim 7, wherein the molecular factor computing sensor comprises a thermal detector.

13. The method of claim 12, wherein the molecular factor computing sensor further comprises an electromagnetic energy source that produces electromagnetic energy that interacts with the substance and is absorbed by an electromagnetic energy absorptive composition of the sensor.

14. A well system, comprising:
at least one molecular factor computing sensor that outputs a signal indicative of a chemical identity of a substance in a subterranean well, and
wherein the substance flows between an earth formation and a wellbore that penetrates the formation.

15. The system of claim 14, wherein the at least one molecular factor computing sensor comprises multiple molecular factor computing sensors, and wherein each of the sensors outputs the signal indicative of the chemical identity of the substance.

16. The system of claim 14, further comprising a flow control device which is adjusted in response to the signal, and wherein the flow control device controls a flow of the substance.

17. The system of claim 14, wherein the molecular factor computing sensor transmits the signal to a remote location.

18. The system of claim 14, wherein the molecular factor computing sensor comprises a thermal detector.

19. The system of claim 18, wherein the molecular factor computing sensor further comprises an electromagnetic energy source that produces electromagnetic energy that interacts with the substance and is absorbed by an electromagnetic energy absorptive composition of the sensor.

20. The system of claim 19, wherein the electromagnetic energy produced by the electromagnetic energy source is relatively broadband.
